(19) United States
(12) Patent Application Publication
(10) Pub. No.: US 2002/0169728 A1
(43) Pub. Date: Nov. 14, 2002

(54) Modular franking system

(76) Inventors: Christian Moy, Grossaffoltern (CH); Daniel Fluckiger, Munsingen (CH); Peter Stutz, Hinterkappelen (CH)

Correspondence Address: PERMAN & GREEN, 425 POST ROAD, FAIRFIELD, CT, 06430, US

(21) Appl. No.: 10/081,278

(22) Filed: Feb. 21, 2002

Related U.S. Application Data
(60) Provisional application No. 60/270,796, filed on Feb. 23, 2001.
(60) Provisional application No. 60/277,806, filed on Mar. 22, 2001.
(60) Provisional application No. 60/277,841, filed on Mar. 22, 2001.
(60) Provisional application No. 60/277,873, filed on Mar. 22, 2001.
(60) Provisional application No. 60/277,931, filed on Mar. 22, 2001.
(60) Provisional application No. 60/277,946, filed on Mar. 22, 2001.
(60) Provisional application No. 60/338,892, filed on Nov. 5, 2001.

(51) Int. Cl. G06F 17/00; G07B 17/02

(52) U.S. Cl. 705/401; 705/402

(57) ABSTRACT

A customized modular mailing system including a module capable of metering value and having a plurality of disabled operating features that are not available for use is described. The system includes the ability for generating an authorization code for disabling certain designed operating features; and for entering the authorization code into the value metering module whereby the desired combination of operating modules having the desired operating features could be placed in communication with the metering value module to create a desired modular mailing system.

### CROSS-REFERENCE TO RELATED APPLICATIONS

This application claims priority of the following U.S. provisional patent applications: Serial No. 60/270,796 filed on Feb. 23, 2001, Serial No. 60/277,806 filed on Mar. 22, 2001, Serial No. 60/277,841 filed on Mar. 22, 2001, Serial No. 60/277,873, filed on Mar. 22, 2001, Serial No. 60/277,931 filed on Mar. 22, 2001, Serial No. 60/277,946 filed on Mar. 22, 2001, Serial No. 60/338,892 filed Nov. 5, 2001 and 60/338,892 filed Nov. 11, 2001.

### BACKGROUND OF THE INVENTION

1. Field of the Invention

This invention relates to a modular mailing system, and more particularly to a digital modular mailing system that can be electronically customized to have a mailing system that includes the users desired features (i.e. desired modules).

2. Brief Description of Related Developments

Value metering devices are devices which in their most basic form meter value. These devices take various forms such as, for example, postage meters (i.e. franking machines), various kinds of vending machines (i.e. lottery vending machines), tax stamp machines, various kinds of ticket dispensing machines, etc. Of these various devices, postage meters are one form of a value metering device that dispense value in the form of postage, e.g. postage indicia, basically either as a stand-alone type postage meter or as part of a mailing system. The stand-alone type postage meter is basically a postage meter having both its entire accounting system and security system positioned in a single secure housing, the accounting system being mechanically coupled to the printing mechanism which prints the postage related indicia. A major issue with stand-alone postage meters is the overall time and cost for any repair or maintenance that needs to be done to the stand alone unit since any repair and/or maintenance needs to be done by a technician who is certified to perform such work by properly opening the securely sealed housing of the postage meter, performing the repair and/or maintenance work, and then resecuring the postage meter once the work is completed. The overall labor cost is therefore high, and the overall time that the meter is not functioning is a relatively long amount of time, i.e. a long amount of downtime.

In addition to the stand-alone type system as described above there are mailing systems which are basically formed of a mailing machine (i.e. a machine that can perform different mailing related functions (e.g. feeding, stacking, separating, sealing of envelopes, etc.) on which a postage meter is securely mounted. The postage meter is typically located in a securely sealed housing which contains the accounting and printing mechanisms. In the past few years both ink jet printing technology and smart card technology (i.e. smart cards used for securely housing the accounting circuitry of the postage meter) have been employed in these postage meters. The mailing machine systems including an electronic postage meter have enabled the users of such equipment to customize the exact type of mailing system they require by designing the overall mailing system in a modular fashion. One is able to set up a mailing system that will include individually removably mounted modules that can be added to or removed from the mailing system. For example, if one had a modular mailing system without an envelope stacker, one could add such a module to their system, and thereby have a mailing system that is able to stack envelopes once the postage has been placed on envelopes that are fed into the system. If the stacker module required repair, the stacker could easily be removed for repair since it is but one module within a modular system. Features such as inserters, feeders/separators, sealers, scales, moisteners, addressers, stackers, etc. can be added for use with a postage meter to form different types of mailing systems.

It is desirable in accordance with the feature of the present invention to have a mailing system that can be securely customized in a fast and reliable manner to control various kinds of external peripherals for handling envelopes. It is also desirable to be able to securely customize a mailing system in accordance with customer needs, and to be able to connect various desired mail related peripherals to a mailing system without the need to provide a separate and dedicated electronic port to achieve such a system.

From a manufacturing point of view, there are also several issues to consider. For example, when postage meters are used in a mailing machine, especially a modular mailing machine, there are many different components to be considered based upon customer requirements. Once a mailing machine with a postage meter is manufactured, the machine is not easily expanded. For instance, if a customer orders another component for their mailing machine, it is generally difficult to add the new component to an existing mailing machine. In addition, the devices used in mailing systems are usually specially designed to work with particular postage meters which tend to make them expensive to manufacture. Each device also has to have special programming to be able to electronically communicate with the postage meter, again increasing the cost of each device. In order to differentiate between each device for communication purposes, each device also requires a unique identifier programmed into each device, and the postage meter. This further increases the cost to customize each device.

### SUMMARY OF THE INVENTION

It is a primary objective of the present invention to have a customized modular mailing machine which basically avoids all of the disadvantages of such a machine as outlined above.

A customized mailing system is obtained by a user in accordance with the features of the present invention which avoids the above stated disadvantages by creating a customized modular mailing system including a module capable of metering value and having a plurality of disabled operating features that are not available for use. The system can generate an authorization code for enabling certain designated operating features, and can enter the authorization code into the value metering module whereby the desired combination of operating modules having the desired operating features can be placed in communication with the metering value module to create the desired modular mailing system.

A further embodiment of the present invention which avoids the above disadvantages provides a customized modular mailing system comprising a value metering module having a plurality of disabled operating features, wherein the disabled operating features are not available for use; the ability to selected at least one of the operating features from the plurality of disabled operating features for enabling such features; a parameter list for storing operating features; the ability to determine a unique serial number from at least one of the selected operating features and adding the unique serial number to the parameter list; the ability to generate an authorization code based on the parameter list for disabling the selected features of the value metering module; and the ability to enter the authorization code into the value metering module for customizing the value metering module with the selected operating features.

A further embodiment of the present invention is for a customized modular mailing system adapted to have added thereto a new operating feature comprising a postage metering module having at least one disabled operating feature which is not available for use, and at least one enabled operating feature which is available for use; the ability to add a new operating feature for adding to the postage metering module from the at least one disabled operating feature; the ability to generate an authorization code from the enabled operating features available for use, and from the selected disabled operating feature; and the ability to enter the authorization code into the postage metering module for enabling the selected operating feature for customizing the postage metering module with the selected operating features.

A still further embodiment of the present invention is for a customized modular mailing system comprised of a plurality of modules including at least; a postage meter module having a security means therein and printing means for printing a postal indicia; and a transport module comprising the ability to transport a document, wherein the postage meter module includes a plurality of disabled operating features that are not available for use, the features related to the function of each of the modules adapted to be placed in electronic communication with the postage meter module; the mailing system further comprising the ability to generate an authorization code for enabling certain designed operating features and means for entering the authorization code into the postage meter module whereby the desired combination of operating modules having the desired operating features can be placed in communication with the postage meter module to thereby create a desired modular mailing system.

A still further embodiment of the present invention is a customized modular mailing system including a module capable of feeding sheets and having a plurality of disabled operating features that are not available for use; a device for generating an authorization code for enabling certain designated operating features; and a device for entering the authorization code into the module capable of feeding sheets whereby the desired combination of operating modules having the desired operating features can be placed in communication with the module capable of feeding sheets to create a desired modular mailing system.

A still further embodiment of the present invention is for a customized modular mailing system including a module capable of performing a mail related function and having a plurality of disabled operating features that are not available for use; means for generating an authorization code for enabling certain designated operating features; and means for entering the authorization code into the module capable of performing a mail related function whereby the desired combination of operating features can be placed in communication with the module capable of performing a mail related function to create a desired modular mailing system.

A still further embodiment of the present invention is a customized modular mailing system including a module capable of metering value and having a plurality of disabled operating features that are not available for use; means for generating an authorization code for enabling designated operating features for a feeder function and a stacker function; and means for entering the authorization code into the value metering module whereby operating features for a feeder function and a stacker function can be placed in communication with the metering value module to create a desired modular mailing system.

A still further embodiment of the present invention is a customized modular mailing system including a module capable of metering value and having a plurality of disabled operating features that are not available for use; means for generating an authorization code for enabling certain designated operating features for a feeder function and a scale function and a stacker function and means for entering the authorization code into the value metering module whereby the desired combination of operating modules having the desired operating features for a feeder function and a scale function and a stacker function can be placed in communication with the metering value module to create a desired modular mailing system.

### BRIEF DESCRIPTION OF THE DRAWINGS

The foregoing aspects and other features of the present invention are explained in the following description taken in connection with the accompanying drawings, wherein:

FIG. 1 is a perspective view of an embodiment of a modular mailing system in accordance with the features of the present invention;

FIG. 2 is a plan block diagram of several combinations of a modular mailing system in accordance with the features of the present invention;

FIG. 3 is a perspective view of another embodiment of a modular mailing system in accordance with the features of the present invention illustrating a mailing system without a postage meter;

FIG. 4 is a perspective view of another embodiment of a modular mailing system illustrating a postage meter module and stacking tray;

FIG. 5 is a perspective view of another embodiment of a modular mailing system illustrating a scale module with a postage meter module; and

FIG. 6 is a perspective view of still another embodiment of a modular mailing system illustrating a scale module feeder/separator module, a postage meter module and a stacker module.

### DETAILED DESCRIPTION OF THE PREFERRED EMBODIMENTS

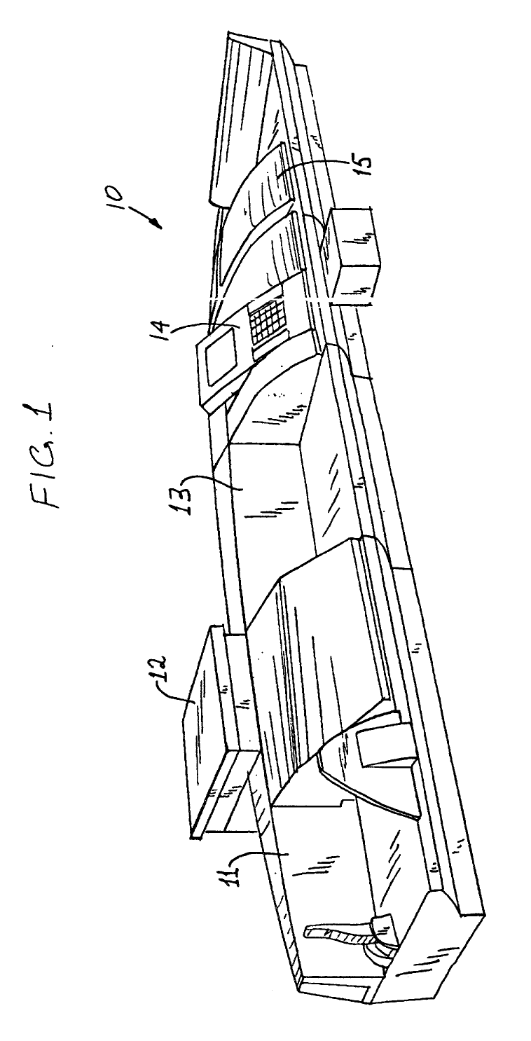

FIG. 1 illustrates one embodiment of a modular mailing system 10 in accordance with the features of the present invention. The specific embodiment shown includes a feeder module 11, both a static weighing module 12 and a dynamic weighing module 13, a postage metering module 14 and a stacker module 15.

The feeder module 11 or feeder/separator module or feeder/separator/moistener module can be a table, for manual feed, a driven feeder, a feeder/sealer or a feeder/separator/moistener in the form of a feeder module 11 that will handle mixed mail. Instead of a feeder module 11, the modular franking system can be attached to an inserter for inserting materials into envelopes, either directly or it can be electronically and mechanically connected through an inserter connect. The purpose of feeder module 11 is to feed envelopes from a stack of envelopes for processing by the mailing machine. Envelopes of different thicknesses and sizes can be separated and fed by feeder module 11. A detailed description of the details of a feeder/separator module that can be used in the present invention is described in commonly assigned and copending U.S. patent Applicationa Ser. No. ______, filed on ______, for “SEPARATOR” by Hans Jaeger, Stefan Etter and Thomas Gasser (Attorney Docket No. 770P010685-US (PAR)), the details of which are hereby incorporated in this application by reference. The sealer can contain a moistener to moisten the flap of an envelope being fed by the system, and then press the moistened flap onto the envelope for sealing the envelope as it is being carried by the belts in the feeder. A detailed description of the kind of moistener apparatus that can be used in the feeder/separator module 11 in accordance with the features of the present invention is described in detail in commonly assigned and copending U.S. patent application Ser. No. ______, filed on ______, for “LETTER MOISTENER” by Alain Saurer, Stefan Etter and Thomas Gasser (Attorney Docket No. 770P010686-US (PAR)), the details of which are hereby incorporated within this application by reference. A feeder module without a sealer can be used where the feeder simply separates envelopes for feeding into the system, one at a time. Mixed mail can be fed; that is, mail having different sized envelopes and envelopes of different thicknesses. The weighing module in accordance with the features of the present invention can be both separate or together, i.e. static weighing and/or dynamic weighing. The static scale 12 module can sit anywhere in the system and in FIG. 1 is shown on top of the feeder/separator module 11. Its purpose is to weigh envelopes. It can be connected to mailing machine 10 through a CAN (i.e. Controller Area Network) bus arrangement as is described in commonly assigned and copending U.S. patent application Ser. No. ______, filed ______, (Attorney Docket No. 770P010638-US (PAR)) the details of which are incorporated in this application by reference for “COMMUNICATION SYSTEM FOR FRANKING SYSTEM”, by Peter Stutz. Any of the modules used in the modular mailing system described herein can be connected to mailing machine 10 through a CAN as explained in the above Attorney Docket 770P010638-US (PAR). The static scale 12 can be authorized to enable different types of weighing modes. For instance, it can weigh in a differential mode by placing a whole stack of envelopes on its weighing pad. The static scale can be connected to the mailing system 10 and is configured in accordance with the invention described and claimed herein. For example, the configuration in the United States would be configured to lock out metric measurement so that only english measurements are calculated by the scale. The dynamic scale 13 weighs on the fly. It can be configured to weigh in the static mode for large packages.

The stacking module 15 which is located to the right of postage meter 14 for collecting and stacking envelopes having different sizes and thicknesses can be in the form of a simple tray, a conveyor system, a bundler or a stacker having the details of the stacker described in copending and commonly assigned U.S. patent application Ser. No. ______, filed ______, for “STACKER” by Thomas Gasser, Dan Ancliffe and Mitch Heeney (Attorney Docket No. 770P010687-US (PAR)), the details of which are incorporated by reference within the present application.

The mailing system (machine) 10 includes a postage meter module 14. The postage meter module can in accordance with the features of the present invention (i) contain a printing device for printing the postage on the envelopes; (ii) include a MMI (Man Machine Interface) or keyboard and touch screen for interface with the operator to select various inputs for each envelope run; (iii) include a vault which is a secure device to keep track of the postage and is necessarily connected to the postage meter module to dispense postage; (iv) include a letter transport to transport letters one at a time through the postage meter module for application of postage; (v) include an RCM (i.e. a Rate Calculation Module) that provides the rates which the postage meter module uses to calculate postage; (vi) have Connectivity; in one particular embodiment of the mailing system 10, the postage meter module 14 can contain the main computer which enables connectivity to the peripheral devices automatically; (vii) include an entry authorization code, i.e. a twenty (20)-digit authorization code; once entered, which permits the postage meter module 14 to authorize configuration of the system; i.e. configures the system exactly as the customer orders it. This can be done by TMS (i.e. Tele Meter Setting); credit card, type insertion, chip card, etc. The postage meter module 14 also acts as a host computer for the system. However, the host is not necessarily the master computer, and a multi-master arrangement can be used. The method by which a computerized mailing system is customized in accordance with its operating features is described in copending and commonly assigned U.S. patent application Ser. No. ______, filed ______, for “CONFIGURATION ENABLEMENT OF FRANKING MACHINE” by Peter Stutz, (Attorney Docket No. 770P010689-US (PAR)), the details of which are herein incorporated by reference.

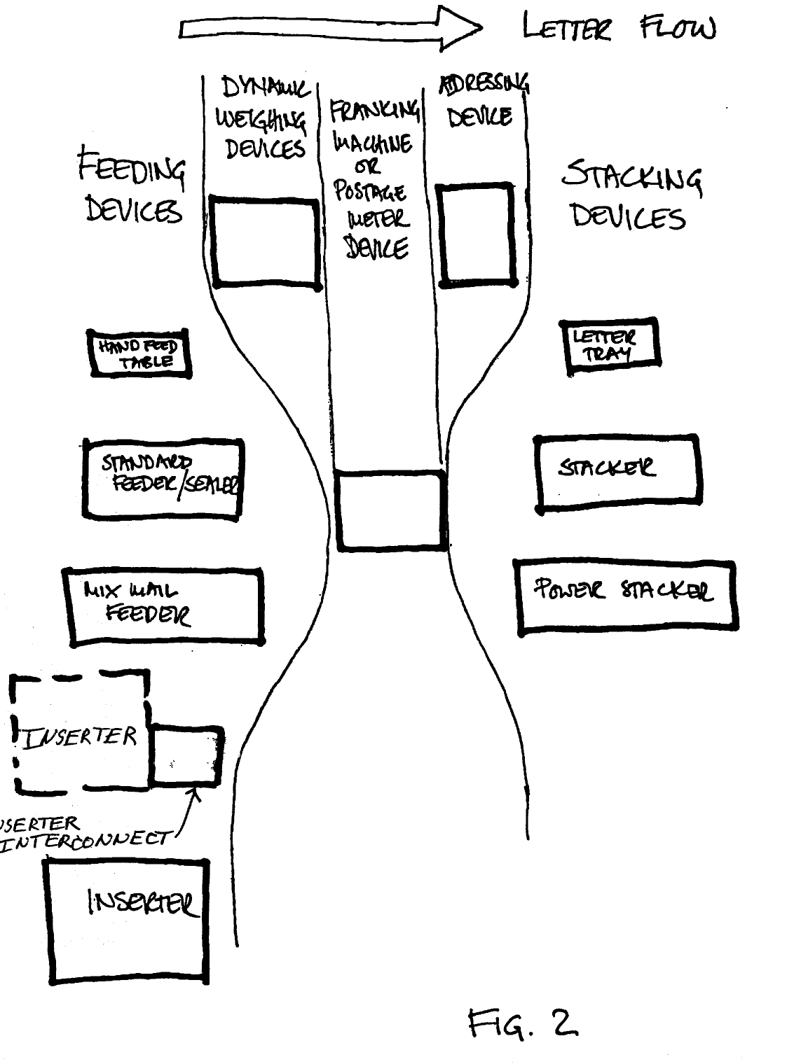

Although not specifically shown in the drawings, the modular mailing system of this invention can be configured in accordance with the features of the present invention to include other features, such as, an addresser function, i.e. a reader that reads information printed on the envelope, such as a bar code, in order to have the printing unit print the address on the envelope and/or a bar code reader. See FIG. 2 illustrating examples in a modular mailing system of various features that can be connected via the concept of modularity as defined herein.

Other miscellaneous devices can be configured to be part of the mailing system 10 in accordance with the invention described herein such as, for example, personal computers. Also, an inserter or an inserter connect as illustrated in FIG. 2 can be automatically configured into the mailing system as described herein.

To configure the modular system, the manufacturer of the mailing system described herein basically uses an algorithm to generate a so called feature number, which is the decimal conversion of a 16 digit number in a binary bit pattern. The “0”'s and “1”'s in the number represent a machine feature value, inputs or other functions of the system, such as “1” for high speed version (10K/mail pc/hr) or “2” for very high speed version (13 Kmail pc/hr) or “0” for base machine or “7” for dynamic scale, etc.

A typical, or example of an authorization number is a 20 digit number. The information that goes into the number may include:

Postage Meter Serial Number

PSD Serial Number

ASM Card Serial Number

ASM Card Version Number

RCM Card Serial Number

RCM Card Version Number

The feature number representing what the customer has ordered for the machine.

An example of how a manufacturer authorizes a customer to activate a mailing system is as follows: The system and PSD (postal security device) are delivered to the customer. Also, the manufacturer sends the customer separately, such as by mail, a 20 digit number. The customer (or dealer) plugs in the machine, inserts the PSD in the postage meter module and calls up the manufacturer. The customer then punches in the 20 digit number and the number enables the system and PSD to link up together to form an operating system. This enables the PSD (through the 20 digit number) to work only with the mailing machine as configured for the customer. This is the feature that a PSD is only authorized to operate in connection to a specific host. The 20 digit number is also used to link the RCM (rate card) and ASM (firmware card) to the system and PSD. The PSD is locked into the postage meter module base by a lock and key.

The postage meter module 14 in accordance with the features of the present invention employs a process wherein initialization of the mailing system 10 occurs by merely inserting the PSD (postal security device) in the postage meter module 14; a small separate PSD (postal security device)—when engaged with the postage meter module—enables the secure dispensing of funds and creates encrypted postage indicia. The PSD, when sent to the customer, contains all of the customer information preloaded by the manufacturer including postal code. In the setup process, the PSD is inserted into the postage meter and the postage meter as well as the other modular components such as feeder, moistener, stacker scale, etc. that are connected together, are initialized. This is normally done through a communication link with the manufacturer such as by telephone. The postage indicia are printed based on the information in the PSD. In the prior art the “town circle” that denotes the location of the postage meter is normally provided by a die that has to be engraved. The setup in the mailing machine according to the features of the present invention is therefore very easy and quick and completely controlled by the manufacturer. The PSD is inserted in the postage meter module, and the customer puts in the manufacturers telephone number and the system, through TMS (i.e. Tele Meter Setting) downloads all the needed programs and parameters for the particular mailing system to get up and running. The initialization occurs with the one phone call.

Postage meters of a particular type for a particular country all have the same software and hardware. Each country has different carrier requirements, so hardware and software for a postage meter differ from country to country. The authorization code has several different uses, including enabling and disabling features of the machine, e.g. according to the present invention, selecting one of three different speeds of letter flow.

Each selected feature according to the present invention causes the generation of a different authorization code. The authorization code is also affected by other factors, such as the serial number of the machine, and the number of the PSD/SAFE. The U.S. Post Office requires that each SAFE work with only one machine.

The manufacturer keeps a table of all the features selected by each customer (user). If a customer's mailing machine needs replacing, an authorization code can be generated which provides the same features in the replacement mailing machine. The database of customer data in the customer mailing machine would also have to be copied to the new mailing machine. If a customer desires that another feature be added to the mailing machine, only a new authorization code has to be transmitted to the customer. Since the postage meters of a particular type for a specific country all have the same software and hardware with all features, the new authorization code enables the requested features.

An example of a postage meter ordering process is as follows:

The distributor in a country e.g. Germany, first receives an order for a customized modular mailing machine having certain features that are desired by the customer. The distributor already has in stock a postage meter module satisfying the customer's order. The customer's system specifications are entered on the internet on the manufacturers web site by the distributor. An authorization number is then automatically generated and displayed or transmitted to the distributor. The distributor only then needs to enter the authorization code into the postage meter module to have the system customized to the customer's specifications. No hardware or software need be delivered to the distributor, as all features are already in the postage meter module and basically only require enablement.

The mailing system 10 according to the present invention can employ a dynamic scale module 13 to weigh the envelope while the envelopes are moving. Prior art systems generally stop each piece of mail, weigh each piece and then imprint the correct postage on the envelope. The prior art systems can handle mail generally at about 30-100 mail pieces/minute. The mailing system described herein in contrast, does all the necessary steps without stopping the envelope. The envelope is fed from the stack and sealed; weighed; the rate is calculated; the postage is set and the postage placed on the envelope while the envelope is continuously moving. The mailing system as described herein can run at about 100-120 mail pieces/minute with all types of mail and can handle mixed mail.

The modularity of the modular mailing system as described herein is largely a result of the CAN serial bus as described in copending and commonly assigned U.S. patent application Ser. No. ______, filed ______, for “COMMUNICATION SYSTEM FOR FRANKING SYSTEM” by Peter Stutz (Attorney Docket No. 770P010638-US (PAR)). When the system powers up, the modular mailing system 10 knows what modules exist in the particular system under consideration, everything is then brought to a proper operating state. The postage module 14 contains the Touch Screen, keyboard and main computer for the entire system. Each module is attached to the postage meter module by the CAN bus and a power cable. There is only one cord from a wall plug to the mailing system 10 which runs between the outlet and the postage meter module 14. The power for all the modules then comes from the postage meter module. This eliminates a confusion of cords required with competitive systems wherein each module must be plugged into the wall outlet or a powerstrip. This arrangement reduces the electrical noise level.

In prior art modular machines, the various modules are placed adjacent one another and if appropriate care is not taken there are typically misfeeds. The postage meter module in accordance with the present invention has a unique set of interface plates, which require the various modules to be aligned properly. An interface plate is placed on the table under one side of the module. The plate contains placement holes for the next module to slip into and be aligned perfectly with the first module. The plates are used between each module to perfectly align the entire mailing system.

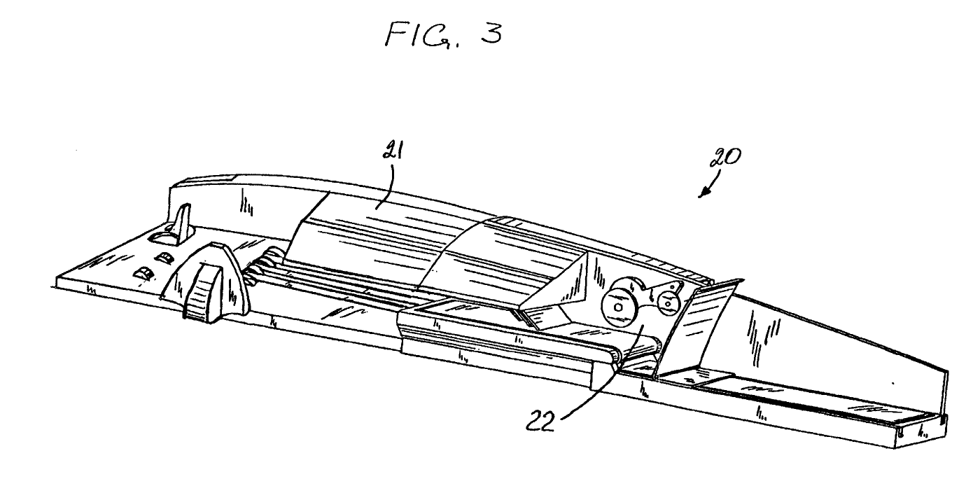

As illustrated in FIG. 3, modular mailing system 20 according to the features of the present invention can be a modular mailing system within the meaning of the present invention and be formed of a feeder/separator 21 module with or without a moistener unit (not shown) but therein in combination with a stacker module 22. When forming such a modular mailing system, the computer controls that would enable certain disabled features to operate by receiving the proper authorization code are located in either the feeder module 21 or the stacker module 22.

Various examples of the possible or different kinds of modular mailing systems (machines) for handling the flow of letters or various sizes and thicknesses that can be customized in accordance with the present invention are given below:

| Inserter | | | | Postage | Address | |
|---|---|---|---|---|---|---|
| Connect | Feeder | Sealer | Dynamic | Meter | Module | Stacker |
| | | | | X | | |
| | | X | | X | | |
| | X | | | X | | |
| | X | | | X | | X |
| | X | | X | X | | X |
| | X | | X | X | X | X |
| X | | | | X | | X |
| | X | | | | | X |

It should be noted that the examples in the above table of different kinds of modular mailing systems are not limited to only the examples given. In accordance with the features of the present invention many others are possible.

Examples of some of the specifications with regard to the modular mailing systems (machines) as described herein are as follows:

1. Letter processing speeds from about 8,000 to about 13,000 letters per hour.

2. Letters in envelopes ranging in size from about 3½″×5″ to about 10″×14″.

3. Letters that in thickness range from about 7 mils to about ½ inch.

4. Letters that weigh from about 4 g to about 600 g.

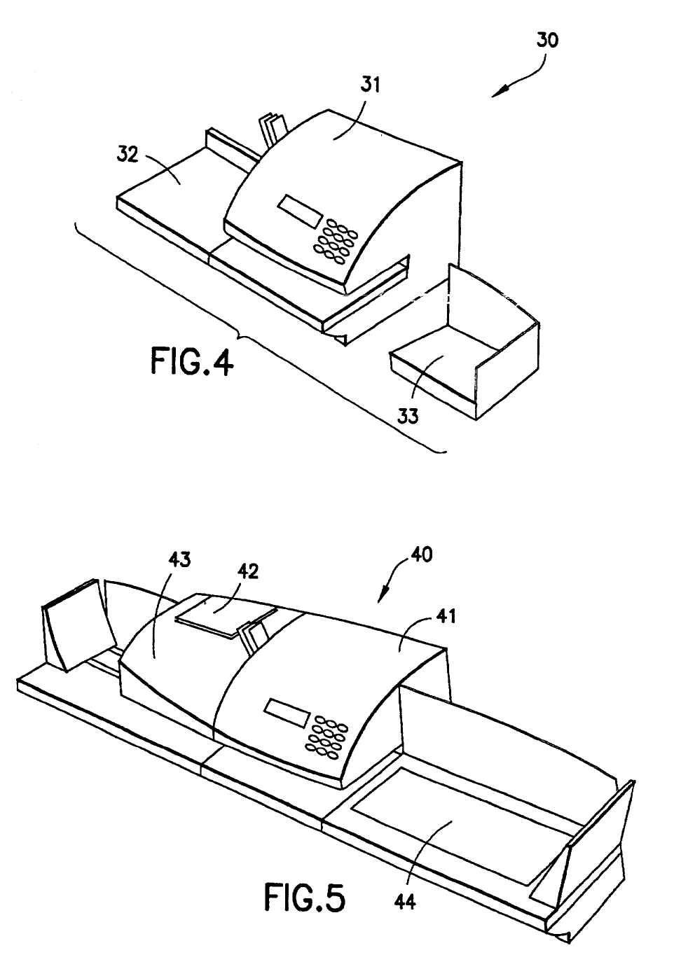

FIG. 4 illustrates a modular mailing system 30 that is relatively simple and includes a postage meter module 31 and a feeding table 32 and a stacking tray 33.

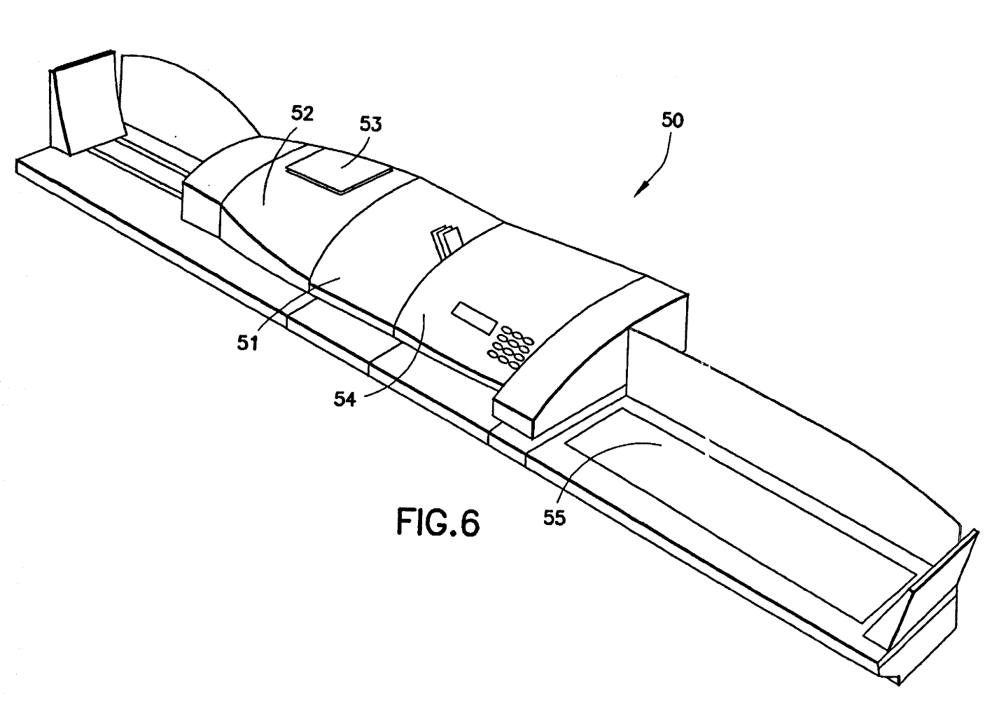

FIG. 5 illustrates another more complicated modular mailing system 40 with a postage meter module 41, a static weighing module 42, a feeder/separator/moistener module 43 and a stacker module 44.

FIG. 6 illustrates another slightly more sophisticated customized modular mailing system 50 which includes a dynamic scale 51 (including a static scale 53) along with a feeder/separator/moistener module 52, postage meter module 54 and stacker module 55.

It should be understood that the foregoing description is only illustrative of the present invention. Various alternatives and modifications can be devised by those skilled in the art without departing from the invention. Accordingly, the present invention is intended to embrace all such alternatives, modifications and variances which fall within the scope of the appended claims.

What is claimed is:

1. A customized modular mailing system including a module capable of metering value and having a plurality of disabled operating features that are not available for use; means for generating an authorization code for enabling certain designated operating features; and means for entering the authorization code into the value metering module whereby the desired combination of operating modules having the desired operating features can be placed in communication with the metering value module to create the desired modular mailing system.

2. A customized modular mailing system according to claim 1, wherein said module capable of metering value is a postage meter.

3. A customized modular mailing system according to claim 1, wherein said disabled operating features include both hardware implemented features and software implemented features.

4. A customized modular mailing system according to claim 3, wherein said features include a scale and a postal security device.

5. A customized modular mailing system according to claim 4 wherein said scale is a dynamic scale or a static scale.

6. A customized modular mailing system according to claim 3, wherein said features include an accounting related system and a selection of letter flow speed.

7. A customized modular mailing system comprising:
a value metering module having a plurality of disabled operating features, wherein the disabled operating features are not available for use;
means for selecting at least one of the operating features from the plurality of disabled operating features for enabling such features;
a parameter list for storing operating features;
means for determining a unique serial number from at least one of the selected operating features and adding the unique serial number to the parameter list;
means for generating an authorization code based on the parameter list for enabling the selected features of the value metering module; and
means for entering the authorization code into the value metering module for customizing the value metering module with the selected operating features.

8. A customized modular mailing system according to claim 7, further comprising:
means for transmitting said parameter list to a third party; and
means for receiving said authorization code from the third party.

9. A customized module mailing system according to claim 8, wherein said third party is the manufacturer of said value metering modules.

10. A customized modular mailing system according to claim 7, wherein said value metering module is a postage meter and the system includes means for determining a country and a postal carrier for which the postage meter will be used.

11. A customized modular mailing system according to claim 7, wherein said features include a scale, a stacker, an envelope sealing mechanism, an envelope moistening apparatus, a feeder/separator, an inserter, and an addresser.

12. A customized modular mailing system adapted to have added thereto a new operating feature comprising:
a postage metering module having at least one disabled operating feature which is not available for use, and at least one enabled operating feature which is available for use;
means to add a new operating feature for adding to the postage metering module from the at least one disabled operating feature;
means for generating an authorization code from the enabled operating features available for use, and from the selected disabled operating feature; and
means to enter the authorization code into the postage metering module for enabling the selected operating feature for customizing the postage metering module with the selected operating features.

13. A customized module mailing system in accordance with claim 12, wherein generating an authorization code includes generating a revenue required for said selected operating feature.

14. A customized modular mailing system in accordance with claim 12, wherein generating an authorization code includes:
transmitting said enabling operating features available for use and said selected disabled operating feature to a third party; and
receiving the authorization code from the third party.

15. A customized modular mailing system in accordance with claim 14, wherein said third party to whom is transmitted said parameter list is a postage meter machine manufacturer.

16. A customized modular mailing system according to claim 14, wherein transmitting said enabling operating features available for use and said selected disabled operating feature to said third party includes transmitting via the internet to said third party.

17. A customized modular mailing system according to claim 14, wherein receiving said authorization code from said third party includes receiving said authorization code via the internet.

18. A customized modular mailing system according to claim 12, wherein entering said authorization code into said postage meter further includes creating an update chip card having the authorization code for releasing said disabled operator feature for use and inserting the update chip card into said postage meter and loading said authorization code from the chip card into said postage meter.

19. A customized modular mailing system comprised of a plurality of modules including at least:
a postage meter module having security means therein and printing means for printing a postal indicia; and a transport module comprising means for transporting a document, wherein the postage meter module includes a plurality of disabled operating features that are not available for use; the mailing system further comprising means for generating an authorization code for enabling certain designated operating features and means for entering the authorization code into the postage meter module whereby the desired combination of operating modules having the desired operating features could be placed in communication with the postage meter module to thereby create a desired modular mailing system.

20. A customized modular mailing system according to claim 19, further comprising a scale module.

21. A customized modular mailing system according to claim 19, further comprising a document stacking module.

22. A customized modular mailing system according to claim 19, wherein said document is an envelope.

23. A customized modular mailing system according to claim 22, further comprising an envelope sealing module.

24. A customized modular mailing system including a module capable of feeding sheets and having a plurality of disabled operating features that are not available for use; means for generating an authorization code for enabling certain designated operating features; and means for entering the authorization code into the module capable of feeding sheets whereby the desired combination of operating modules having the desired operating features could be placed in communication with the module capable of feeding sheets to create a desired modular mailing system.

25. A customized modular mailing system according to claim 24, wherein said module capable of feeding sheets and is also capable of separating sheets.

26. A customized modular mailing system according to claim 25, wherein said module capable of feeding sheets is also capable of moistening.

27. A customized modular mailing system according to claim 1, wherein said disabled operating features include both hardware implemented features and software implemented features.

28. A customized modular mailing system according to claim 24 wherein said sheets are envelopes.

29. A customized modular mailing system according to claim 24 wherein one of said disabled features is for a stacker.

30. A customized modular mailing system including a module capable of performing a mail related function and having a plurality of disabled operating features that are not available for use; means for generating an authorization code for enabling certain designated operating features; and means for entering the authorization code into the capable of performing a mail related function module whereby the desired combination of operating modules having the desired operating features could be placed in communication with the module capable of performing a mail related function to create a desired modular mailing system.

31. A customized modular mailing system including a module capable of metering value and having a plurality of disabled operating features that are not available for use; means for generating an authorization code for enabling designated operating features for a feeder function and a stacker function; and means for entering the authorization code into the value metering module whereby the desired combination of operating modules having the operating features for a feeder function and a stacker function could be placed in communication with the metering value module to create a desired modular mailing system.

32. A customized modular mailing system including a module capable of metering value and having a plurality of disabled operating features that are not available for use; means for generating an authorization code for enabling certain designated operating features for a feeder function and a scale function and a stacker function; and means for entering the authorization code into the value metering module whereby the desired combination of operating modules having the desired operating features for a feeder function and a scale function and a stacker function could be placed in communication with the metering value module to create a desired modular mailing system.

33. A customized modular mailing system according to claim 31 wherein said feeder function includes both a sheet separator and moistening function.

34. A customized modular mailing system according to claim 32 wherein said feeder function includes both a sheet separation and moistening function.
